(19) United States
(12) Patent Application Publication
(10) Pub. No.: US 2007/0235678 A1
(43) Pub. Date: Oct. 11, 2007

(54) Lock-cap structure of stopcock of water faucet

(76) Inventor: Chiu-Chih Chung, Chunghua Hsien (TW)

Correspondence Address: TROXELL LAW OFFICE PLLC, SUITE 1404, 5205 LEESBURG PIKE, FALLS CHURCH, VA, 22041, US

(21) Appl. No.: 11/397,621

(22) Filed: Apr. 5, 2006

(51) Int. Cl. F16K 31/44

(52) U.S. Cl. 251/214

(57) ABSTRACT

An improved lock-cap structure of stopcock of water faucet, which covers an external sleeve onto stopcock of water faucet, its characteristics are as follows: Inner of external sleeve is set as phase layer with through hole and screw thread groove, edge of screw thread groove can place leakage protective gasket; several grooves are set on bolt of stopcock, which are applied to ring seal; so that ring seal and leakage protective gasket can stop water in two sections in through hole and edge of screw thread groove, therefore, such structure can exactly stop water, stopcock can be rotated smoothly.

### BACKGROUND OF THE INVENTION

1) Field of the Invention

This invention relates to an improved lock-cap structure of stopcock of water faucet, which is covered by external sleeve, inner of external sleeve is set as phase layer with through hole and screw thread groove, bolt crossing through hole with stopcock, ring seals cover groove to seal through hole, then leakage protective gasket in screw thread groove blocks water-controlling port of faucet, so, it can stop water in radial and axial direction, function of water faucet is thereby reinforced.

2) Description of the Prior Art

Please refer to FIG. 1 and FIG. 2 for the traditional lock-cap structure of stopcock of water faucet, wherein stopcock II of water faucet 1 is covered with external sleeve 12, screw groove 121 is set at center of external sleeve 12 so as to rotate into lock screw cap 2; phase ring 122 is below bottom of screw groove 121 of external sleeve 12, and leakage protective gasket R and metal ring R1 are placed into phase ring in advance, stable Teflon R2 is fixed on top of metal ring R1, furthermore, clearance A is between bottom of metal ring R1 and phase ring 122; so, as lock screw cap 2 is locked onto Teflon R2 from top of screw groove 121 of external sleeve 12, due to clearance A between metal ring R1 and phase ring 122, the locked pressure can only press leakage protective gasket R to stop water in advance, however, this pressure can not reach Teflon R2 to have stable pressure (as shown in FIG. 2).

### SUMMARY OF THE INVENTION

I. Problem to Solve:

A. Above described structure is to lock up external sleeve by proper pounds of weight, its multilayered gaskets are easy to make pressure of lock-up position be unequal, which may impact efficiency of water faucet to stop water.

B. Gaskets can not be piled up level due to unequal pressure. If the lock-up is too loose, it may leak due to clearance formed, if it is locked too tight, stopcock can not rotate easily.

C. Such faucet is assembled by too many components, which may raise cost, and it is also difficult to maintain.

II. Solutions:

1. Water faucet of this invention is covered by external sleeve, inner of external sleeve is set as phase layer with through hole and screw thread groove, bolt crossing through hole with stopcock, ring seals cover groove to seal through hole, then leakage protective gasket in screw thread groove blocks water-controlling port of faucet; so that it can stop water in radial and axial direction.

2. External sleeve of this invention can be controlled easily, so that it can stop water effectively and precisely, moreover, roundness of ring seal is compatible with rotational movement of stopcock (can not block), so, it can rotate easily.

3. It is structured simply, so, it can be easily assembled, production cost can also be reduced and convenient to maintain.

### BRIEF DESCRIPTION OF THE DRAWINGS

FIG. 1 is the exploded view of stop cock of prior water faucet.

FIG. 2 is the section map of stop cock of prior water faucet.

FIG. 3 is the exploded view of this invention.

FIG. 4 is the exploded combination view of this invention.

FIG. 5 is the stop locating section map of this invention.

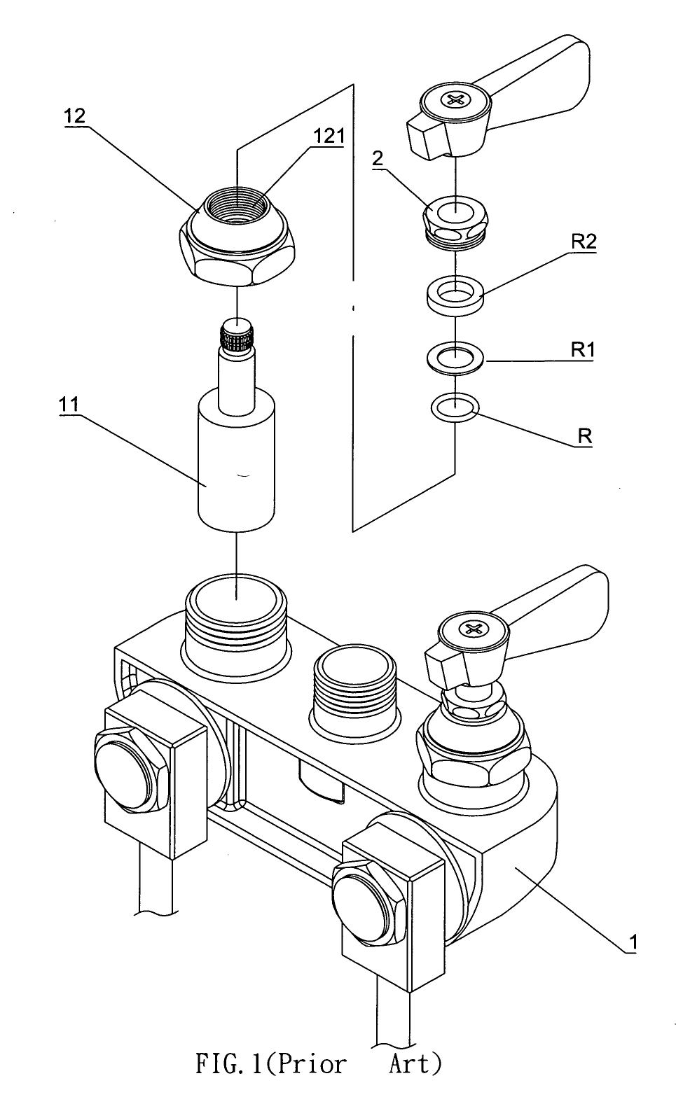

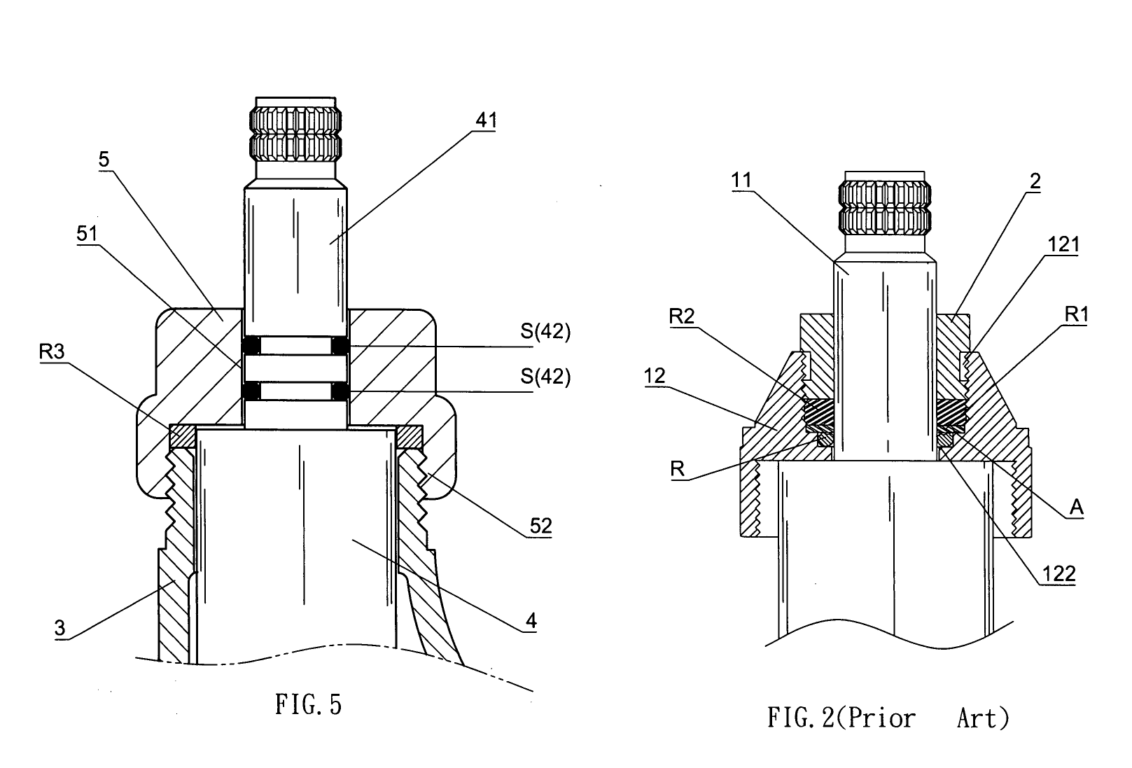

### DETAILED DESCRIPTION OF THE PREFERRED EMBODIMENTS

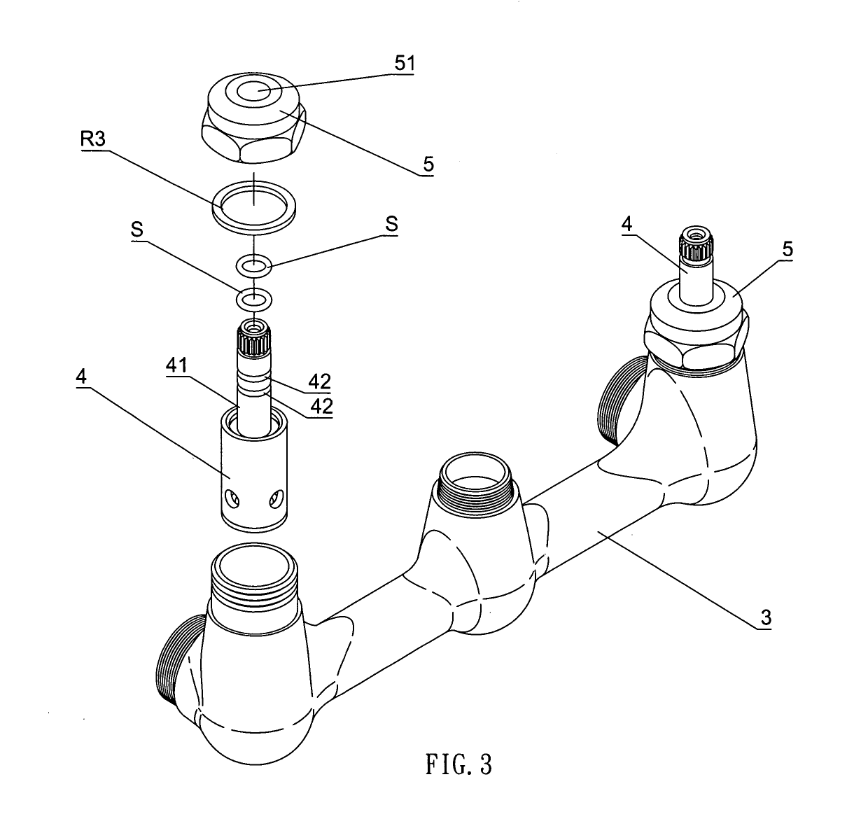

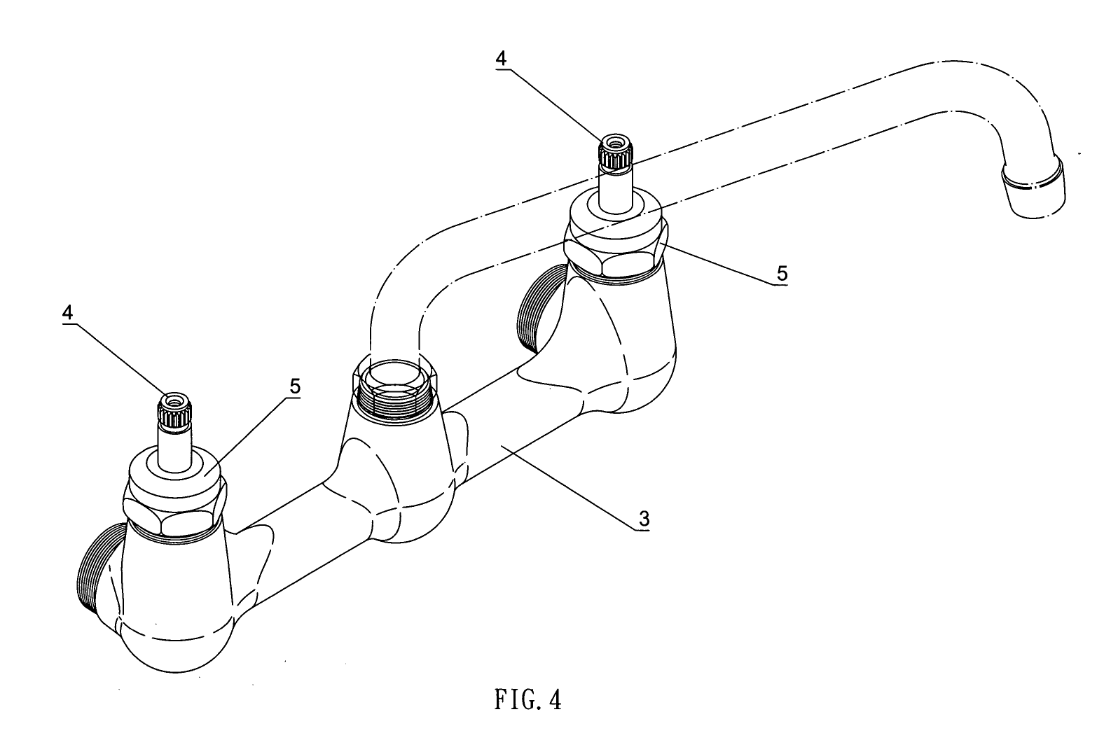

Please refer to FIG. 3, FIG. 4 and FIG. 5 for structure of this invention. Stopcock 4 of water faucet 3 of this invention is covered with external sleeve 5; key points of this structure are as follows: inner of external sleeve 5 is set as phase layer 52 with through hole 51 and screw thread groove 52, edge of screw thread groove 52 can place leakage protective gasket R3; several grooves 42 are set on bolt 41 of stopcock 4 for ring seal S, which are applied for ring seal; so that ring seal S and leakage protective gasket R3 can respectively stop water in axial and radial sections in through hole 51 and edge of screw thread groove 52, therefore, such structure can exactly stop water, moreover, because stopcock 4 rotates along tangent of ring seal S, so, it can rotate smoothly (refer to FIG. 5), function of water faucet is thereby reinforced.

What is claimed is:

1. An improved lock-cap structure of stopcock of water faucet, which covers an external sleeve onto stopcock of water faucet, its characteristics are as follows:
Inner of external sleeve is set as phase layer with through hole and screw thread groove, edge of screw thread groove can place leakage protective gasket; several grooves are set on bolt of stopcock, which are applied to ring seal; so that ring seal and leakage protective gasket can stop water in two sections in through hole and edge of screw thread groove, therefore, such structure can exactly stop water, stopcock can be rotated smoothly.
